(19) United States
(12) Patent Application Publication
(10) Pub. No.: US 2018/0032865 A1
(43) Pub. Date: Feb. 1, 2018

(54) PREDICTION APPARATUS, PREDICTION METHOD, AND PREDICTION PROGRAM

(71) Applicants: DENSO CORPORATION, Kariya-city (JP); TOKYO INSTITUTE OF TECHNOLOGY, Tokyo (JP)

(72) Inventors: Hiroki Nishimura, Kariya-city (JP); Satoshi Matsuoka, Tokyo (JP); Akihiro Nomura, Tokyo (JP); Yosuke Oyama, Tokyo (JP); Ikuro Sato, Yokohama (JP)

(21) Appl. No.: 15/439,304

(22) Filed: Feb. 22, 2017

(30) Foreign Application Priority Data
Jul. 29, 2016 (JP) 2016-150221

(51) Int. Cl. G06N 3/08; G06N 3/04

(52) U.S. Cl. CPC G06N 3/08; G06N 3/04

(57) ABSTRACT

In a prediction apparatus for a learning system, an obtaining unit obtains, as input variables, at least one parameter indicative of a structure of a convolutional neural network, the number of nodes of a learning system, and a sub-batch number indicative of the number of pieces of training data collectively processed by at least one graphic processing unit. A predictor predicts at least one of learning time and an average mini-batch size as a function of the input variables obtained by the obtainer. The learning time is time required for one update of all the weights by a central processing unit. The average mini-batch size is an average number of pieces of training data used for the one update of all the weights.

### CROSS REFERENCE TO RELATED APPLICATIONS

This application is based on and claims the benefit of priority from Japanese Patent Application 2016-150221 filed on Jul. 29, 2016, the disclosure of which is incorporated in its entirety herein by reference.

### TECHNICAL FIELD

The present disclosure relates to prediction apparatuses, prediction programs, and prediction methods for predicting at least one of learning time taken to learn the weights of a learning system, and an average mini-batch size of the learning system; the learning system updates the weights of convolutional neural networks using nodes.

### BACKGROUND

Generic object recognition is one of the ultimate goals in image recognition research. This is to estimate categories, i.e. classes, to which objects, such as birds and vehicles included in images, belong. Recently, performance of generic object recognition has greatly improved due to the progress of convolutional neural networks having many layers.

An example of such convolutional neural networks is disclosed in the following non-patent document 1:

Ren Wu, Shengen Yan, Yi Shan, Qingqing Dang, and Gang Sun, “Deep Image: Scaling up Image Recognition”, arXiv: 1501.02876, 2015.

Various recognition algorithms have been proposed in the image recognition field. There is a tendency that the recognition performance of the convolutional neural networks is higher than the recognition performance of each of the other recognition algorithms as the volume of data becomes enormous.

Convolutional neural networks have higher ability of expressing a target model, but may cause overlearning or overtraining. The overlearning or overtraining means that a learning algorithm learned based on a training dataset excessively fits the features of the training dataset. However, a large increase of the volume of a training dataset up to a level that can avoid the occurrence of the overlearning enables the convolution neutral networks to be widely used.

### SUMMARY

The convolutional neural networks have a great advantage in recognition performance, but also have a weakness of requiring long learning time when they are learned. Learning of the convolutional neural network means a task to optimize parameters, such as weights and biases, of the convolutional neural network. Datasets associated with social networks or datasets associated with autonomous driving are an example of ever-increasing datasets. Using such an enormous volume of a dataset for learning a convolutional neural network may increase the learning time of the convolutional neural network, resulting in a risk that the learning may be unfinished within a realistically allowable time length. For example, learning of a convolutional neural network based on such an enormous volume of a dataset may require one or more years.

Prolonged learning of a convolutional neural network may reduce the practicality of the convolutional neural network. This may result in users having no choice but using recognition algorithms other than convolutional neural networks.

That is, it is a very important issue in industry to speed up learning of convolutional neural networks.

For addressing the above issue, users have tried to use a computer cluster to establish a learning system; the compute cluster is configured such that a plurality of computers, such as nodes, each of which includes one or more central processing units (CPUs) and/or one or more graphics processing units (GPUs), are communicably connected to each other. That is, users have tried to perform distributed learning of the weights in such a computer cluster of the learning system. This aims to greatly shorten the learning time of the weights of the learning system. Examples of these attempts are disclosed in the following non-patent documents 2 to 5 in addition to the non-patent document 1:

Non-patent document 2: Written by D. Amodei, et. al, “Deep Speech 2: End-to-End Speech Recognition in English and Mandarin”, arXiv: 1512.02595, 2015

Non-patent document 3: Written by S. Zhang, C. Zhang, Z. You, R. Zheng, and B. Xu, “Asynchronous stochastic gradient descent for dnn training”, Acoustics, Speech and Signal Processing (ICASSP), 2013 IEEE International Conference on, pages 6660. 6663, May 2013

Non-patent document 4: Written by Forrest N. Iandola, Khalid Ashraf, Mattthew W. Moskewicz, Kurt Keutzer, “FireCaffe: near-linear acceleration of deep neural network training on compute clusters”, arXiv: 1511.00175, 2015

Non-patent document 5: Written by S. Gupta, W. Zhang, and J. Milthorpe, “Model Accuracy and Runtime Tradeo in Distributed Deep Learning”, arXiv: 1509.04210, 2015

Establishing a proper learning system preferably needs prediction of the relationship between the structure of the learning system and the learning time.

Gradient methods are known as an example of learning methods. In particular, mini-batch stochastic gradient descent, which uses part of all pieces of training data, is widely used; the mini-batch stochastic gradient descent will be referred to simply as mini-batch learning. The mini-batch represents the number of pieces of training data used for one updating of the weights, and the mini-batch size represents the number of pieces of training data constituting the mini-batch.

The mini-batch size has a proper range. If the mini-batch size were out of the proper range, there could be a higher possibility of the occurrence of problems, such as reduction in the convergence rate and generalization capability of the learning (see non-patent documents 2, 3, and 5). Performing the mini-batch learning using a compute cluster preferably needs prediction of the relationship between the structure of the learning system and the mini-batch size.

In view of the circumstances set forth above, one aspect of the present disclosure seeks to provide prediction apparatuses, prediction methods, and prediction programs for a learning system that updates the weights of convolutional neural networks using nodes. In particular, another aspect of the present disclosure seeks to provide such prediction apparatuses, prediction methods, and prediction programs, each of which is capable of predicting at least one of learning time taken to learn the weights of the learning system, and an average mini-batch size of the learning system.

According to a first exemplary aspect of the present disclosure, there is provided a prediction apparatus for a learning system. The learning system includes a plurality of nodes each including a central processing unit and at least one graphics processing unit. The central processing unit of each node uses the at least one graphics processing unit to calculate, based on a plurality of pieces of training data, a quantity of update of each weight included in a convolutional neural network. The central processing unit of each node performs a weight updating cycle that communicates the quantity of update of each weight with at least one other central processing unit of at least one other node to perform update of the corresponding weight of the convolutional neural network. The prediction apparatus includes an obtaining unit configured to obtain, as input variables, at least one parameter indicative of a structure of the convolutional neural network, the number of the nodes of the learning system; and a sub-batch number indicative of the number of pieces of training data collectively processed by the at least one graphic processing unit. The prediction apparatus includes a predictor configured to predict at least one of learning time and an average mini-batch size as a function of the input variables obtained by the obtainer. The learning time is time required for one update of all the weights by the central processing unit. The average mini-batch size is an average number of pieces of training data used for the one update of all the weights.

According to a second exemplary aspect of the present disclosure, there is provided a prediction method for a learning system. The learning system includes a plurality of nodes each including a central processing unit and at least one graphics processing unit. The central processing unit of each node uses the at least one graphics processing unit to calculate, based on a plurality of pieces of training data, a quantity of update of each weight included in a convolutional neural network. The central processing unit of each node performs a weight updating cycle that communicates the quantity of update of each weight with at least one other central processing unit of at least one other node to perform update of the corresponding weight of the convolutional neural network. The prediction method includes obtaining, as input variables, at least one parameter indicative of a structure of the convolutional neural network, the number of the nodes of the learning system; and a sub-batch number indicative of the number of pieces of training data collectively processed by the at least one graphic processing unit. The prediction method includes predicting at least one of learning time and an average mini-batch size as a function of the input variables obtained by the obtainer. The learning time being time required for one update of all the weights by the central processing unit, and the average mini-batch size is an average number of pieces of training data used for the one update of all the weights.

According to a third exemplary aspect of the present disclosure, there is provided a computer program product for a learning system. The learning system includes a plurality of nodes each including a central processing unit and at least one graphics processing unit. The central processing unit of each node uses the at least one graphics processing unit to calculate, based on a plurality of pieces of training data, a quantity of update of each weight included in a convolutional neural network. The central processing unit of each node performs a weight updating cycle that communicates the quantity of update of each weight with at least one other central processing unit of at least one other node to perform update of the corresponding weight of the convolutional neural network. The computer program product includes a non-transitory computer-readable storage medium, and a set of computer program instructions stored in the computer-readable storage medium, the instructions causing a computer to carry out

(1) A first step of obtaining, as input variables, at least one parameter indicative of a structure of the convolutional neural network, the number of the nodes of the learning system; and a sub-batch number indicative of the number of pieces of training data collectively processed by the at least one graphic processing unit

(2) A second step of predicting at least one of learning time and an average mini-batch size as a function of the input variables obtained by the obtainer.

The learning time is time required for one update of all the weights by the central processing unit, and the average mini-batch size is an average number of pieces of training data used for the one update of all the weights.

Each of the first to third exemplary aspects of the present disclosure enables the corresponding learning system, which is capable of providing a proper mini-batch size and/ or proper learning time based on the structure of the corresponding learning system, to be designed.

### BRIEF DESCRIPTION OF THE DRAWINGS

Other aspects of the present disclosure will become apparent from the following description of embodiments with reference to the accompanying drawings in which:

FIG. 1 is a block diagram schematically illustrating an example of the structure of a convolutional neural network according to a present embodiment of the present disclosure;

FIG. 2 is a block diagram schematically illustrating an example of the hardware structure of a learning system according to the present embodiment;

FIG. 3 is a block diagram schematically illustrating an example of the detailed operations of each learning thread and the detailed operations of an AR thread in the learning system illustrated in FIG. 2;

FIG. 4A is a pseudocode schematically illustrating an example of the detailed algorithm of each learning thread;

FIG. 4B is a pseudocode schematically illustrating an example of the detailed algorithm of the AR thread;

FIG. 5 is a time chart schematically illustrating an example of how the learning threads and the AR thread of each node are operated over time;

FIG. 6 is a block diagram schematically illustrating a prediction apparatus according to the present embodiment;

FIG. 7 is a block diagram schematically illustrating an example of the structure of a predictor illustrated in FIG. 6; and

FIG. 8 is a pseudocode schematically illustrating an example of a convolution and back propagation algorithm carried out by the AR thread.

### DETAILED DESCRIPTION OF EMBODIMENT

The following describes a present embodiment of the present disclosure with reference to the accompanying drawings. In the embodiments, like parts between the embodiments, to which like reference characters are assigned, are omitted or simplified in description to avoid redundant description.

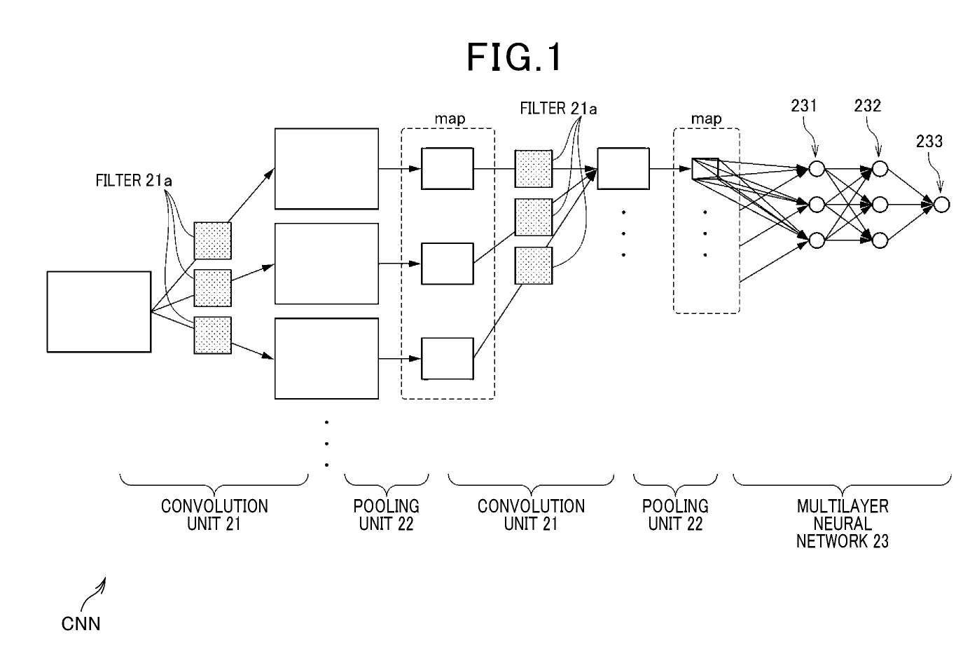

FIG. 1 schematically illustrates an example of the structure of a convolutional neural network (CNN) according to the present embodiment.

The CNN includes a convolution-layer portion comprised of at least one pair of the set of convolution units 21 and the set of pooling units 21, and a multilayer neural network structure 23. In FIG. 1, the first stage of the set of convolution units 21 and the set of pooling units 22, and the second stage of the set of convolution units 21 and the set of pooling units 22 are provided in the CNN as an example.

An image I having a predetermined two-dimensional pixel size, which is a recognition target of the CNN, is input to the convolution units 21 of the first stage. The multilayer neural network structure 23 outputs the result of recognition of the input image I by the CNN.

Each of the convolution units 21 of the first stage convolves an input image, such as the input image I as the recognition target, using at least one filter 21a, and non-linearly maps the result of the filtering. Each of the convolution units 21 of the second stage convolves an input image, which is a feature map described later, using at least one filter 21a, and non-linearly maps the result of the filtering.

Each of the filters 21a has a predetermined pixel size lower than the pixel size of an input image; each pixel of the corresponding filter 21a has a weight, i.e. weight value. The weight of each pixel of each of the filters 21a can be biased.

Each of the pooling units 22 downsamples the output image signal of the corresponding one of the convolution units 21 to lower resolution of the output image signal, thus generating a feature map.

The multilayer neural network structure 21 includes an input layer 231, at least one intermediate layer, i.e. at least one hidden layer, 232, and an output layer 233. Each of the input layer 231 and the at least one hidden layer 232 includes plural units, i.e. neurons. Each unit, also called a node, serves as, for example, a functional module, such as a hardware module like a processor. The output layer 233 includes at least one unit, i.e. at least one node.

To the input layer 231, the feature maps output from the pooling units 22 of the last stage, that is, the second stage according to the first embodiment, are input.

Each unit in the input layer 231 receives the feature maps input thereto from the pooling units 22 of the last stage, and sends the received feature maps to all units in the at least one hidden layer 232.

Each unit in the at least one hidden layer 232 is connected to all the units in the input layer 231. Each unit in the at least one hidden layer 232 receives feature maps input thereto from all the units in the input layer 231, and multiplies each of the feature maps by a weight defined for a corresponding one of the units in the input layer 231.

If there are N hidden layers 232 (N is an integer equal to or more than 2), each unit in the i-th hidden layer 232 is connected to all the units in the (i−1)-th hidden layer (i is set to any one of 2 to N). Each unit in the i-th hidden layer 232 receives feature maps input thereto from all the units in the (i−1)-th hidden layer 232, and multiplies each of the feature maps by a weight defined for a corresponding one of the units in the (i−1)-th hidden layer 232.

The at least one unit in the output layer 233 is connected to all the units in the last hidden layer 232. The at least one unit in the output layer 233 receives feature maps input thereto from all the units in the last hidden layer 232. Then, the at least one unit in the output layer 233 multiplies each of the feature maps by a weight defined for a corresponding one of the units in the last hidden layer 232, thus obtaining the result of recognition of the input image I by the CNN.

The weights of the filters 21a and the weights of the multilayer neural network structure 23 represent parameters of the CNN to be learned, i.e. trained. The following the weights included in the CNN are referred to as weights W.

The present embodiment aims to learn the weights W for a shorter time. The learning or training means updating of the weights W of the CNN to enable the CNN to return an ideal output when a target image as a recognition target of the CNN is input to the CNN.

A plurality of training datasets are used for the learning; each of the training datasets includes target images and corresponding pieces of output data. Each of the pieces of output data represents a predetermined ideal output for a corresponding one of the target images.

Before the learning of the CNN, an evaluation function, such as a square error function or cross entropy function, is defined for each of the training datasets. The evaluation function defined for a training dataset quantifies the deviation of the output of the CNN when a target image of the training dataset is input to the CNN from the ideal output of the CNN corresponding to the target image.

The sum of the evaluation functions provide for all the training datasets is defined as a cost function E(W). The cost function E(W) is expressed as a function of the weights W of the CNN. That is, the lower the cost function E(W) is, the higher the evaluation of the CNN.

In other words, the learning also means updating of the weights W of the CNN to minimize the cost function E(W) of the CNN.

The present embodiment uses backpropagation, an abbreviation for “backward propagation of errors” as one type of gradient methods for minimizing the cost function E(W).

The backpropagation repeats updating of the weights W of the CNN many times. One updating of each weight W is represented by the following equation (1):

W←W−r*dW (1)

Where r represents a scalar learning speed, and dW represents the differential value of the cost function with respect to each weight W. Note that the expression W←W−r*dW having the symbol “←” represents that the value W−r*dW is substituted into the weight W.

Specifically, updating of each weight W uses a current value of the corresponding weight W and the differential value dW. The learning speed r can be reduced every updating.

A method using the differential value dW calculated based on all the training datasets for one updating of each weight W is referred to as a batch learning. A method using an approximate value of the differential value dW, which is calculated based on some of the training datasets, is referred to as mini-batch learning. Recently, mini-batch learning is usually used, because mini-batch learning has a higher convergence rate and a higher generalization capability than the batch learning. Note that the generalization capability of the CNN represents the recognition capability with respect to an image that is not included in the training datasets.

It is necessary for using the mini-batch learning to determine the mini-batch size. The mini-batch size represents the number of pieces of training data used for one updating of the weights W, i.e. calculation of the differential value dW. The proper mini-batch size, which depends on a problem to be solved by the CNN, is set to be within the range from 1 to approximately 1000. Experience shows that the mini-batch size has a proper value, i.e. a preferred value. If the mini-batch size were set to a value largely exceeding the proper value, the convergence rate and the generalization capability could be lowered. That is, increasing the mini-batch size not necessarily contribute to higher convergence rate and generalization capability. It is well known that the proper value of the mini-batch size is well below the total number of all pieces of the training data.

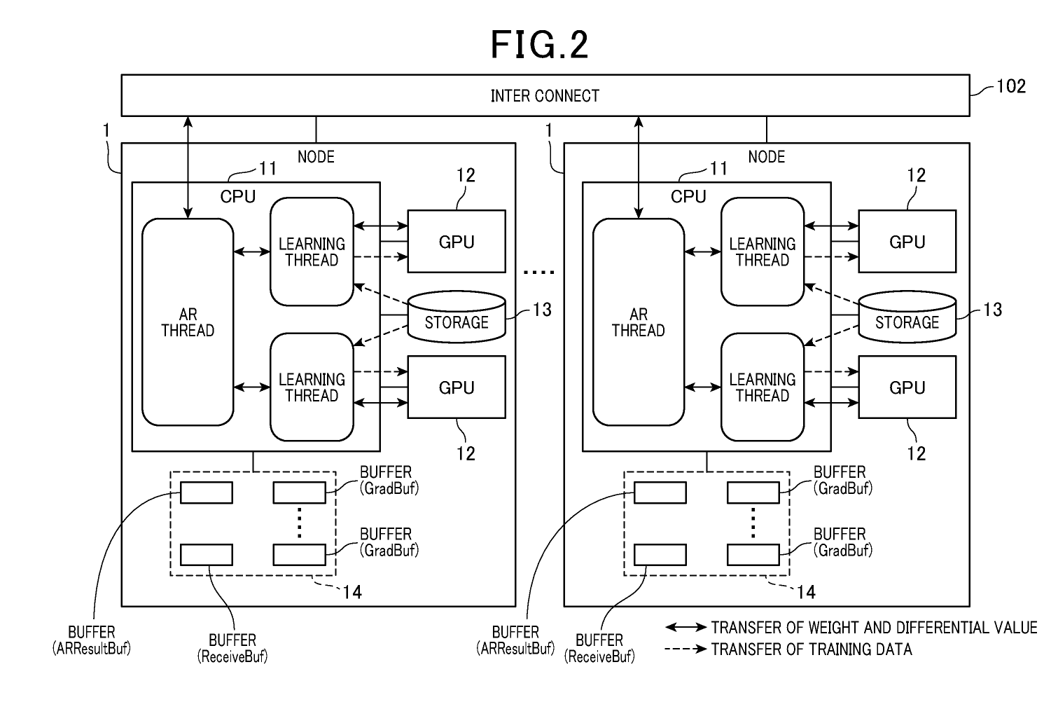

FIG. 2 is a block diagram schematically illustrating an example of the hardware structure of a learning system 100 that performs the mini-batch learning of the CNN.

The learning system 100 is comprised of nodes 1 connected to each other via an inner connect 102; the number of nodes 1 will be expressed by N_{Node}. The nodes 1 enable data communications to be carried out therebetween.

Each of the nodes 1 is, for example, a single processor. Each node 1 is capable of parallelizing a plurality of processes, i.e. programs. Specifically, each node 1 is comprised of a CPU 11, a plurality of GPUs 12, a storage, such as a solid state drive (SSD) 13, and a host memory 14. The number of GPUs 12 will be expressed by NGpu. Note that the nodes 1 have the same number N_{GPU} of GPUs 12.

Each node 1 for example installs therein a message passing interface (MPI) for communication between the nodes 1.

The CPU 11 carries out an AR thread and N_{GPU} number of learning threads. Each learning thread is designed as a process to use the corresponding one of the GPUs 12 to calculate the amount of update of each weight, which corresponds to the differential value dW in the equation (1), asynchronously with the other GPUs 12. The quantity of update of each weight will be referred to as a weight update quantity hereinafter.

The calculation of the weight update quantity by a GPU 12 uses predetermined pieces of training data allocated for the GPU 12 and stored in the storage 13 to cause the GPU 12 to repeatedly perform the learning of each weight of the CNN using the predetermined pieces of training data. Then, integrating the calculated results for each weight enables the weight update quantity for the corresponding weight to be calculated. The weight update quantity of each weight is stored in a buffer GradBuf on the host memory 14. Note that the buffers GradBuf are provided for the respective learning threads, i.e. the GPUs 12.

That is, the learning system 100 is configured as a computer cluster.

The AR thread of one node 1 is designed as a process to communicate with the other nodes 1 to

(1) Update, based on the weight update quantities calculated by all the nodes 1 for each weight, the corresponding weight

(2) Synchronize each weight of the corresponding node 1 with the corresponding weight of each of the other nodes 1.

For example, the AR thread of each node 1 is designed as a process to perform, asynchronously with the learning threads, additional Allreduce algorithm to communicate with the other nodes 1 using the weight update quantities for each weight to update each weight accordingly. The process of the AR thread of each node also stores each of the updated weights in a buffer ARResultBuf on the host memory 14.

Note that the buffers ARResultBuf are provided for the respective AR threads, i.e. the nodes 1.

Each learning thread determines, for each learning, whether a value of each of the weights stored in the buffer ARResultBuf has been updated. Then, each learning thread uses the value of each of the weights stored in the buffer ARResultBuf as the newest value of the corresponding one of the weights when it is determined that the value of each of the weights has been updated.

Hereinafter, the number of pieces of training data collectively used by each GPU 12, i.e. each learning thread, will be referred to as a sub-batch number N_{subbatch}. All pieces of training data are divided to be stored in the storages 13 of the respective nodes 1 before start of learning. Specifically, in each storage 13, pieces of training data, which are accessed by the corresponding GPU 12 for learning, are stored.

Note that FIG. 2 illustrates an example of the hardware structure of the learning system 100. For example, the number of CPUs 11 and the number of GPUs 12 in each node 1 can be freely determined. Each node 11 can have an external storage 13. The learning system 100 can include a single storage 13 that all the nodes 11 can access; all pieces of training data are stored in the single storage 13. In the first embodiment or each modification set forth above, each node 1 can handle training data at high speed.

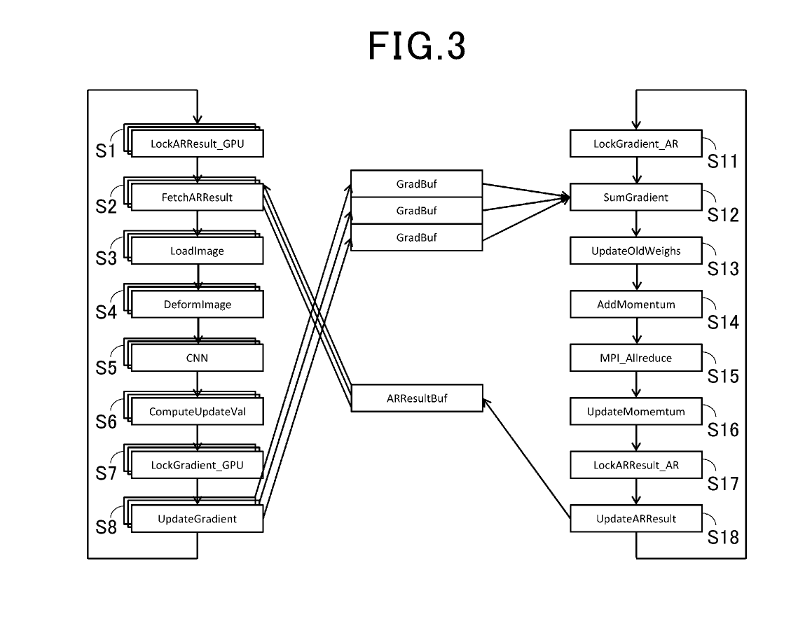

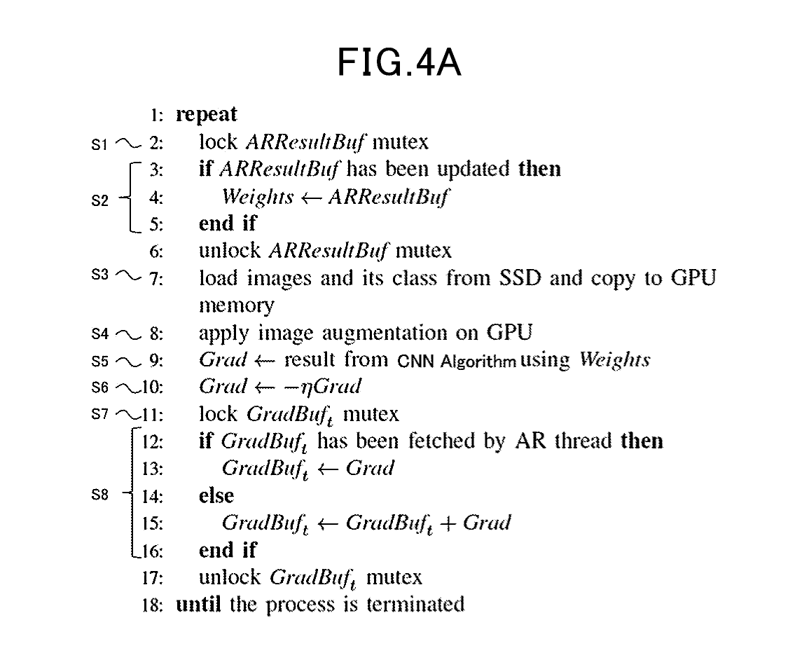

FIG. 3 schematically illustrates an example of the detailed operations of each learning thread and the detailed operations of the AR thread in the learning system 100. FIG. 3 illustrates an example where each node 1 includes three GPUs 12. FIG. 4A illustrates a pseudocode schematically illustrating an example of the detailed algorithm of each learning thread, and FIG. 4B illustrates a pseudocode schematically illustrating an example of the detailed algorithm of the AR thread.

The learning thread for each GPU 12 cyclically executes the following steps S1 to S8 of operations asynchronously with the other learning threads (see FIG. 3 and FIG. 4A):

Step S1, which is expressed by LockARResult_GPU in FIG. 3, represents a process of waiting until the corresponding GPU 12 obtains exclusive control of the buffer ARResultBuf. The time required for step S1 (LockARResult_GPU) will be referred to as lock time. The total sum of the lock times of all the learning threads of each node 1 will be expressed as T_{LockARResult}_{_}_{GPU}.

Step S2, which is expressed by FetchARResult in FIG. 3, represents a process of fetching a value of each weight stored in the buffer ARResultBuf, and copying the fetched values of the respective weight to corresponding parameters Weights when it is determined that the buffer ARResultBuf in the current cycle has been updated after step S2 of the immediately previous cycle. The time required for step S2 (FetchARResult) will be expressed as T_{FetchARResult}.

Step S3, which is expressed by LoadImage in FIG. 3, represents a process of loading the sub-batch number N_{Subbatch} of pieces of training data, i.e. image data, from the storage 13. The time required for step S3 (LoadImage) will be expressed as T_{LoadImage}.

Step S4, which is expressed by DeformImage in FIG. 3, represents a process of applying, to the sub-batch number N_{Subbatch} of pieces of loaded training data, i.e. loaded image data, at least one of various deformations, i.e. various transformations, including

(a) Perspective projection conversion

(b) Projective transformation

(c) Elastic distortion

(d) Lens effect

(e) Cropping

(f) Flip horizontal

(g) Multiplication of random numbers to the red-blue-green (RGB) values of the corresponding one of the loaded image data.

The time required for step S4 (DeformImage) will be expressed as T_{DeformImage}.

Step S5, which is expressed by CNN in FIG. 3, represents known convolution and back propagation based on the deformed pieces of training data, i.e. image data; step S5 will be described in detail later. The time required for step S5 (CNN) will be expressed as T_{CNN}.

Step S6, which is expressed by ComputeUpdateVal in FIG. 3, represents a process of calculating the differential value, i.e. the weight update quantity Grad, for each weight based on the value of the corresponding one of the parameters Weights and the corresponding one of the gradients, which are obtained based on the results of the back propagation. The time required for step S6 (ComputeUpdateVal) will be expressed as T_{ComputeUpdateVal}.

Step S7, which is expressed by LockGradient_GPU in FIG. 3, represents a process of waiting until the corresponding GPU 12 obtains exclusive control of the buffer GradBuf. The time required for step S7 will be expressed as T_{LockGradient}_{_}_{GPU}.

Step S8, which is expressed by UpdateGradient in FIG. 3, represents a process of

(1) Determining whether the value of the buffer GradBuf for each weight has been fetched by the AR thread after step S8 of the previous cycle

(2) Copying the weight update quantity Grad for each weight obtained by step S6 to the buffer GradBuf when it is determined that the value of the buffer GradBuf for each weight has been fetched by the AR thread after step S8 of the previous cycle

(3) Adding the weight update quantity Grad for each weight obtained by step S6 to the value of the buffer GradBuf for the corresponding weight so that the buffer GradBuf is updated when it is determined that the buffer GradBuf for each weight has not been fetched by the AR thread after step S8 of the previous cycle. The time required for step S8 will be expressed as T_{UpdateGradient}.

The time T_{GPU} required for the above-described learning thread to perform one learning cycle, i.e. the calculation of the weight update quantity Grad, is the sum of the times required for the respective processes S1 to S8, which can be expressed by the following equation (2):

T_{GPU}=T_{LockARResult}_{_}_{GPU}+T_{FetchARResult}+T_{LoadImage}+T_{DeformImage}+T_{CNN}+T_{ComputeUpdateVal}+T_{LockGradient}_{_}_{GPU}+T_{UpdateGradient} (2)

The AR thread for each CPU 11 cyclically executes the following steps S11 to S18 of operations asynchronously with the learning threads (see FIG. 3 and FIG. 4B):

Step S11, which is expressed by LockGradient_AR in FIG. 3, represents a process of waiting until the corresponding CPU 11 obtains exclusive control of the buffer GradBuf. The time required for step S11 (LockGradient) will be expressed as T_{LockGradient}_{_}_{AR}.

Step S12, which is expressed by SumGradient in FIG. 3, represents a process of

1. Determining whether the buffers GradBuf for each weight have been updated by the respective learning threads after completion of step S12 of the previous cycle

2. Fetching the sum of the values of the buffers GradBuf for each weight to assign the fetched sum of the values of the buffers GradBuf for each weight to a parameter SendBuf for the corresponding weight when it is determined that at least one of the buffers GradBuf has been updated by the corresponding at least one of the learning threads after completion of step S12 of the previous cycle. The time required for step S12 (SumGradient) will be expressed as T_{SumGradient}.

Step S13, which is expressed by UpdateOldWeights in FIG. 3, represents a process of fetching the j-th current value of the buffer ARResultBuf to the k-th current value of the buffer ARResultBuf when the lank of the MPI is set to n where n ranges from 0 to N_{Node}−1; the current values of the buffer ARResultBuf represent the current values of all the weights of the CNN to be learned. The reference character j is expressed as {(N_{Param}×n)/N_{Node}}, and the reference character k is expressed as [{N_{Param}×(n+1)}/N_{Node}]; the reference character N_{Param} represents the total number of the weights of the CNN to be learned.

The process of step S13 also copies the fetched values of the respective weights of the buffer ARResultBuf to respective parameters Oldweights. The time required for step S13 (UpdateOldWeights) will be expressed as T_{UpdateOldWeights}.

Step S14, which is expressed by AddMomentum in FIG. 3, represents a process of calculating the sum of

(1) The value for each weight stored in the parameter SendBuf

(2) The value of the corresponding one of the parameters Oldweights

(3) The value of the corresponding one of parameters DeltaWeights, which have been calculated in the following step S16 of the immediately previous cycle.

Then, the process of step S14 assigns the calculated sum for each weight to the parameter SendBuf, so that the value of the parameter SendBuf for each weight represents the value of the corresponding weight based on the corresponding node 1. The time required for step S14 (AddMomentum) will be expressed as T_{AddMomentum}.

The process of step S15, which is expressed by MPI_Allreduce in FIG. 3, represents a process of

(1) Transmitting the value of the parameter SendBuf for each weight to the other nodes 1 in the additional Allreduce algorithm

(2) Receiving the value of the parameter SendBuf for each weight sent from each of the other nodes 1 in the additional Allreduce algorithm

(3) Calculate the sum of the values of the parameter SendBuf for each weight obtained by all the nodes 1 to store the calculated sum for each weight into a buffer RecvBuf on the host memory 14.

The value for each weight stored in the buffer RecvBuf represents the updated value of each weight. The time required for step S15 (MPI_Allreduce) will be expressed as T_{MPI}_{_}_{Allreduce}.

Step S16, which is expressed by UpdateMomentum in FIG. 3, represents a process of

(1) Subtracting the value of each of the parameters Oldweights from the corresponding one of the values of the buffer RecvBuf to calculate the differential value of each weight between the corresponding immediately previous value and the corresponding currently obtained value

(2) Assigning the differential value of each weight to the corresponding one of the parameters DeltaWeights. The time required for step S16 (UpdateMomentum) will be expressed as T_{UpdateMomentum}.

Step S17, which is expressed by LockARResult_AR in FIG. 3, represents a process of waiting until the corresponding CPU 11 obtains exclusive control of the buffer ARResultBuf. The time required for step S17 (LockARResult) will be expressed as T_{LockARResult}.

Step S18, which is expressed by UpdateARResult in FIG. 3, represents a process of copying the updated value for each weight stored in the buffer RecvBuf to the buffer ARResultBuf. The time required for step S18 (UpdateARResult) will be expressed as T_{UpdateARResult}.

The time T_{Allreduce} required for the above-described AR thread to perform one weight updating cycle, i.e. the update of each weight, is the sum of the times required for the respective processes S11 to S18, which can be expressed by the following equation (3):

T_{Allreduce}=T_{LockGradient}_{_}_{AR}+T_{SumGradient}+T_{UpdateOldWeights}+T_{AddMomentum}+T_{MPI}_{_}_{Allreduce}+T_{UpdateMomentum}+T_{LockARResult}+T_{UpdateARResult} (3)

That is, the weight updating cycle is carried out by the AR thread, i.e. the CPU 11 of each node, to communicate the weight update quantities with the other nodes to update, based on the weight update quantities calculated by all the nodes 1 for each weight, the corresponding weight.

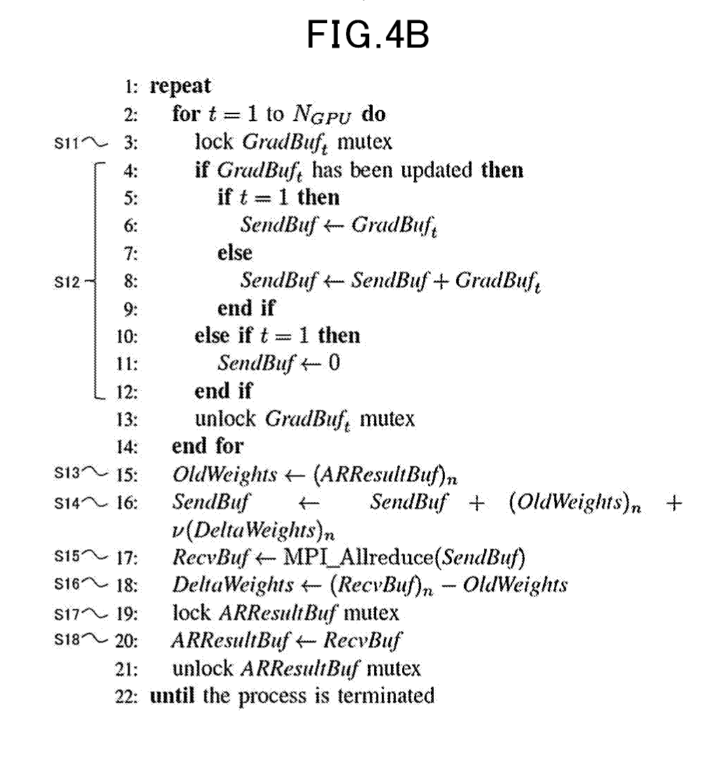

FIG. 5 schematically illustrates an example of how the learning threads and the AR thread of each node 1 are operated over time. To simplify the descriptions of how the learning threads and the AR thread of each node 1 are operated over time, FIG. 5 illustrates two nodes 1 so that the variable N_{Node} is set to 2, and each node 1 includes three GPUs 12, so that the variable N_{GPU} is set to 3. That is, three learning threads and one AR thread are installed in each node 1.

In FIG. 5, hatched or unhatched rectangular blocks each represent one learning task carried out by a corresponding learning thread. That is, each hatched or unhatched rectangular block shows the operations in steps S1 to S8 illustrated in FIGS. 3 and 4A. As illustrated in FIG. 5, the time required for performing each learning task is the time T_{GPU} expressed by the equation (2).

Additionally, rectangular blocks formed by dashed-dot lines each represent one communication and update task carried out by a corresponding AR thread. That is, each rectangular block formed by the dashed-dot line shows the operations in steps S11 to S18 illustrated in FIGS. 3 and 4B. As illustrated in FIG. 5, the time required for performing each communication and update task is the time T_{Allerduce} expressed by the equation (3).

FIG. 5 for example shows that the ratio of the time T_{Allreduce} to the time T_{GPU} is set to 1:3. For this reason, the communication and update task specified by reference numeral 51 updates each weight based on the results of two learning tasks specified by reference characters 52 and 53. Each of the other communication and update tasks also updates each weight based on the results of two learning tasks.

The following generalizes the relations between one communication and update task and the number of learning tasks required by the one communication and update task in accordance with the total number of GPUs 12 being represented by N_{Node}×N_{GPU}. Specifically, one communication and update task uses the results of the learning tasks obtained by the following number NN of learning threads as expressed by the following equation (4):

NN=N_{Node}×N_{GPU}×T_{Allreduce}/T_{GPU} (4)

When the number of pieces of training data collectively processed by each learning thread, which is also called sub-batch number, is represented as N_{Subbatch}, the equation (4) enables the number N_{Batch} of pieces of training data used for one update of all the weights, which represents an average mini-batch size N_{Batch}, to be represented by the following equation (5):

N_{Batch}=(N_{Node}×N_{GPU}×N_{Subbatch}×T_{Allreduce})/T_{GPU} (5)

The learning time T_{Epoch} required for processing all pieces of training data, the total number of which is represented by N_{File}, is expressed by the following equation (6):

$$\begin{matrix}{T}_{Epoch} = {N}_{File} \times {T}_{Allreduce} / {N}_{Batch} \\ = ( {N}_{File} \times {T}_{GPU} ) / ( {N}_{Node} \times {N}_{PGU} \times {N}_{Subbatch} )\end{matrix} \qquad ( 6 )$$

Note that the learning time T_{Epoch} is called epoch time. Epoch is a unit associated with the amount of data used for learning. One epoch means execution of the learning task based on one set of all pieces of training data, the total number of which is represented by N_{File}. N epochs means execution of the learning task based on n sets of all pieces of training data, the total number of which is represented by N_{File}. One epoch time is defined as time required for executing one epoch learning task. Note that many epochs, such as one handled epochs, are required for converging the cost function.

In light of the above descriptions, the present embodiment is configured to predict, based on the number of nodes N_{Node} and the sub-batch number N_{Subbatch}, the learning time T_{Epoch} and/or the average mini-batch size N_{Batch} in accordance with the above equations (5) and (6).

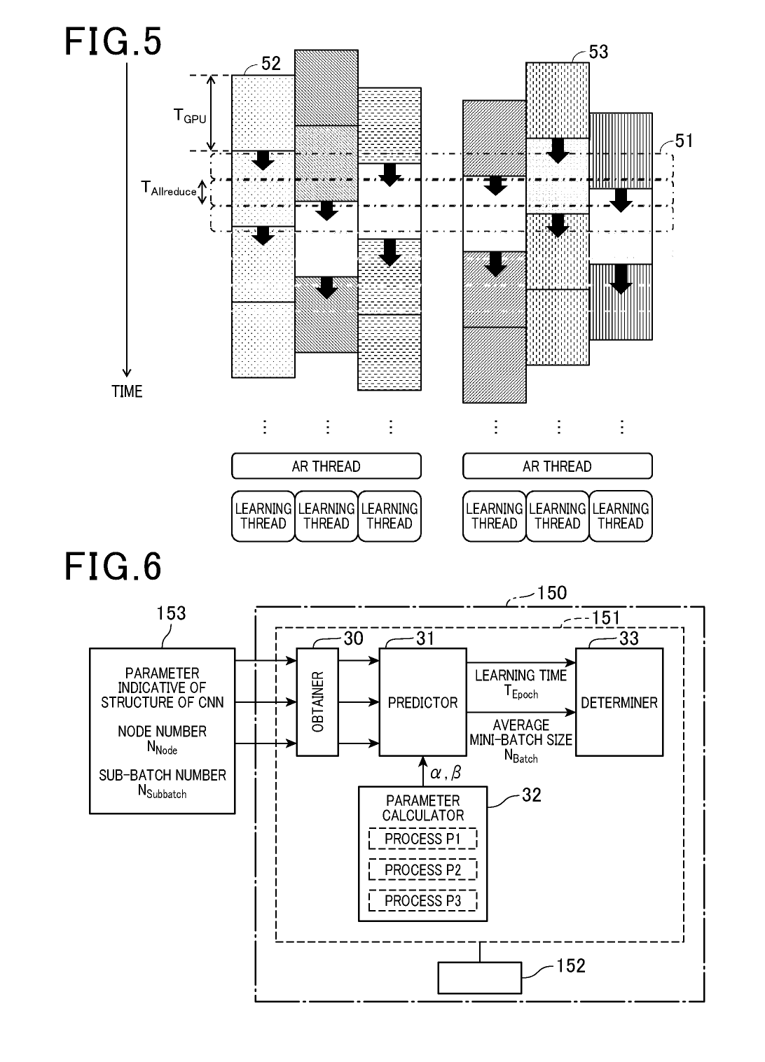

FIG. 6 schematically illustrates a prediction apparatus 150 according to the present embodiment.

The prediction apparatus 150 includes an obtainer 30, a predictor 31, a parameter calculator 32, and a determiner 33. Each of the modules 30 to 33 can be implemented as hardware modules, software modules, or hardware/ software hybrid modules. For example, the prediction apparatus 150 includes a processor, i.e. a computer processor, 151 and a memory, such as a non-transitory computer-readable storage medium, 152. One or more programs, i.e. instructions, stored in the memory 152 cause the processor 151 to implement the above modules 30, 31, 32, and 33. The prediction apparatus 150 can include at least the obtainer 30 and predictor 31, so that the parameter calculator 32 and determiner 33 can be eliminated.

An input device 153 is configured to input, to the prediction apparatus 150, that is, the predictor 31, input variables. The input variables include parameters indicative of the CNN to be learned, the number of nodes N_{Node}, and the number of pieces of training data that each GPU should collectively process, i.e. the sub-batch number N_{Subbatch}. The number of nodes N_{Node} will also be referred to as a node number N_{Node}.

The obtainer 30, which serves as an input interface of the predictor 31, receives the input parameters. The predictor 31 predicts, based on the input parameters received by the obtainer 30, the learning time T_{Epoch} and the average mini-batch size N_{Batch} in accordance with the prediction model equations described later. Then, the predictor 31 outputs the learning time T_{Epoch} and the average mini-batch size N_{Batch} as output parameters. Note that the predictor 31 can predict, based on the input parameters, one of the learning time T_{Epoch} and the average mini-batch size N_{Batch} in accordance with the prediction model equations described later.

The parameter calculator 32 calculates, based on the structure of the learning system 100, parameters α and β that are used to calculate the time T_{Allreduce} and the time T_{GPU}. Detailed descriptions of the parameter calculator 32 will be described later together with descriptions of calculations of the time T_{Allreduce} and the time T_{GPU}.

The determiner 33 determines whether the calculated average mini-batch size N_{Batch} is proper, more specifically, lies within a predetermined proper range.

The determiner 33 can be configured to select some of, preferably all of, proper pairs of values of the node number N_{Node} and the sub-batch number N_{Subbatch}; the calculated average mini-batch size N_{Batch} becomes proper when each of the selected pairs of values of the node number N_{Node} and the sub-batch number N_{Subbatch} is used in the structure of the CNN to be learned.

The determiner 33 can also be configured to identify one of the selected proper pairs of values of the node number N_{Node} and the sub-batch number N_{Subbatch}; the learning time T_{Epoch} based on the identified one of the selected proper pairs of values of the node number N_{Node} and the sub-batch number N_{Subbatch} becomes minimum. This enables the proper weights to be learned in the fastest time.

The determiner 33 can further be configured to identify one of the selected proper pairs of values of the node number N_{Node} and the sub-batch number N_{Subbatch}; the node number N_{Node} based on the identified one of the selected proper pairs of values of the node number N_{Node} and the sub-batch number N_{Subbatch} becomes minimum. This enables the proper weights to be learned while the number of nodes 1 is kept minimum.

In addition, the determiner 33 can be configured to identify one of the selected proper pairs of values of the node number N_{Node} and the sub-batch number N_{Subbatch}; the node time, which is defined as the product of the node number N_{Node} and the learning time T_{Epoch}, based on the identified one of the selected proper pairs of values of the node number N_{Node} and the sub-batch number N_{Subbatch} becomes minimum. This enables the proper weights to be learned while reducing the node time, i.e. resource occupation time.

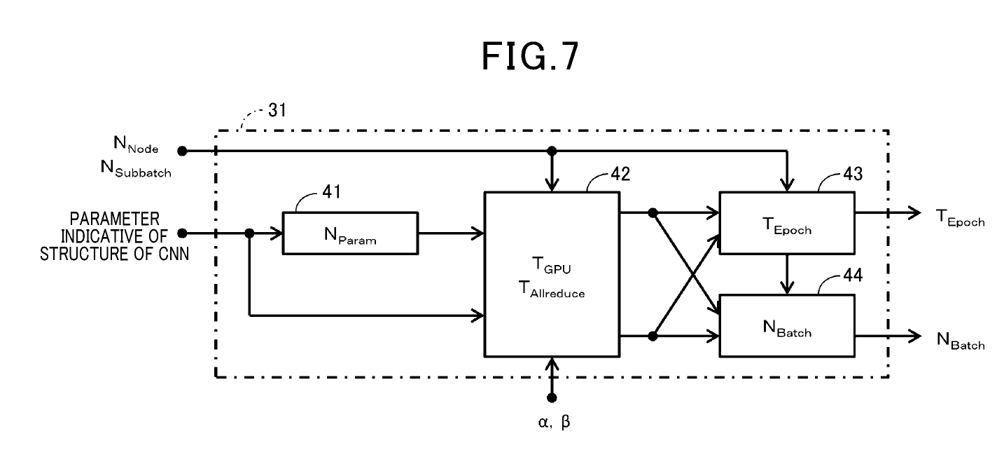

FIG. 7 schematically illustrates an example of the structure of the predictor 31. The predictor 31 includes an N_{Param} calculator 41, a T_{GPU}·T_{Allreduce} calculator 42, a T_{Epoch} calculator 43, and an N_{Batch} calculator 44. The N_{Param} calculator 41 is simply expressed by N_{Param} in FIG. 7, and the T_{GPU}·T_{Allreduce} calculator 42 is simply expressed by T_{GPU} T_{Allreduce} in FIG. 7. The T_{Epoch} calculator 43 is simply expressed by T_{Epoch} in FIG. 7, and the N_{Batch} calculator 44 is simply expressed by N_{Batch} in FIG. 7.

The T_{Epoch} calculator 43 calculates the learning time T_{Epoch} in accordance with the equation (6), and the N_{Batch} calculator 44 calculates the average mini-batch size N_{Batch} in accordance with the equation (5).

The following mainly describes the N_{Param} calculator 41 and the T_{GPU}·T_{Allreduce} calculator 42.

Each of the time T_{Allreduce} and the time T_{GPU} depends on the total number N_{Param} of the weights of the CNN to be learned. The N_{Param} calculator 41 therefore calculates the total number N_{Param} of the weights. The total number N_{Param} of the weights depends on the structure of the CNN to be learned.

As illustrated in FIG. 1, the CNN includes the total number L of layers. The total number L of the layers of the CNN includes Lc convolution layers of the CNN, and full-connection layers based on the multilayer neural network structure.

For example, the N_{Param} calculator 41 calculates the total number N_{Param} of the weights in accordance with the following equation (7):

$${N}_{Param} = {\sum }_{l = 1}^{Lc} {m}_{l} ( {c}^{2} {m}_{l - 1} + 1 ) + {\sum }_{l = {L}_{c} + 1}^{L} {m}_{l} ( {{x}_{l - 1}}^{2} {m}_{l - 1} + 1 ) \qquad ( 7 )$$

Where Lc represents the number of the convolution layers of the CNN, mₗ represents the number of maps in the l-th layer where m₀ represents the number of maps in the input layer, c represents the convolution filter size of the CNN, L represents the total number of the layers of the CNN, and xₗ represents the map size of the l-th layer of the CNN (see FIG. 1). The values of these parameters Lc, mₗ, c, L, and xₗ are input to the predictor 31 as the parameters indicative of the CNN by the input device 153.

The T_{GPU} and T_{Allreduce} calculator 42 executes a process of calculating the time T_{GPU} and the time T_{Allreduce} in accordance with the total number N_{Param} of the weights and the above equation (2) and/or the above equation (3).

First, the following describes how the T_{GPU} and T_{Allreduce} calculator 42 calculates the time T_{GPU} in accordance with the equation (2).

To simplify the following descriptions, we show the equation (2) again as follows:

T_{GPU}=T_{LockARResult}_{_}_{GPU}+T_{FetchARResult}+T_{LoadImage}+T_{DeformImage}+T_{CNN}+T_{ComputeUpdateVal}+T_{LockGradient}_{_}_{GPU}+T_{UpdateGradient} (2)

The time T_{LockARResult}_{_}_{GPU} represents the total sum of the lock times of each learning thread, which is expressed by the following equation (2A):

T_{LockARResult}_{_}_{GPU}=T_{UpdateARResult}²/(2×T_{Allreduce})+(N_{GPU}−1)×T_{FetchARResult}²/(2×T_{GPU}) (2A)

Note that the time T_{FetchARResult} is expressed by the equation (2B) described later, and the time T_{UpdateARResult} is expressed by the following equation (3E) described later:

The time T_{FetchARResult} depends on whether the buffer ARResultBuf in the current cycle has been updated after step S2 of the immediately previous cycle. The probability of the buffer ARResultBuf having been updated is estimated to be the value expressed by T_{GPU}/T_{Allreduce} when the time T_{Allreduce} is equal to or higher than the time T_{GPU}, or the value of 1 when the time T_{Allreduce} is lower than the time T_{GPU}.

This estimation enables the time T_{FetchARResult} to be expressed by the following equation (2B):

T_{FetchARResult}=α1×N_{subbatch}×min(T_{GPU}/T_{Allreduce}, 1) (2B)

Where α1 represents a fixed parameter, which depends on the learning system 100, and is previously calculated by the parameter calculator 32.

Note that the function min (A, B) represents a function returning one of A and B, which is lower than the other.

The time T_{LoadImage} represents the time required to read the sub-batch number N_{Subbatch} of pieces of training data, i.e. image data, from the storage 13; the time T_{Loadlmage} is expressed by the following equation (2C):

T_{LoadImage}=α2×N_{Subbatch}+β2 (2C)

Where α2 and β2 respectively represent fixed parameters, which depend on the learning system 100, and are each previously calculated by the parameter calculator 32.

The time T_{DeformImage} represents the time required to apply, to the sub-batch number N_{Subbatch} of pieces of training data, at least one of various deformations set forth above, which is expressed by the following

T_{DeformImage}=α3×N_{Subbatch}+β3 (2D)

Where α3 and β3 respectively represent fixed parameters, which depend on the learning system 100, and are each previously calculated by the parameter calculator 32.

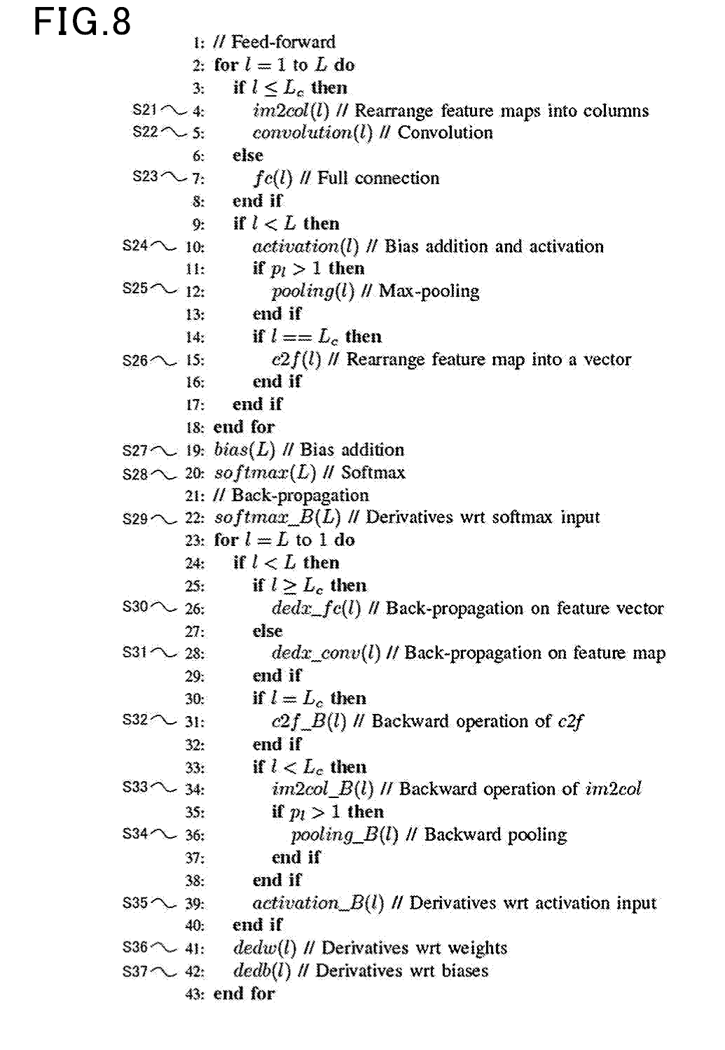

The time T_{CNN} is defined as time required to perform the convolution and back propagation based on the sub-batch number N_{Subbatch} of pieces of training data, i.e. image data. Specifically, the time T_{CNN} is defined as time required for each AR thread to perform a convolution and back propagation algorithm based on the deformed pieces of training data, i.e. image data as illustrated in FIG. 8 described hereinafter.

First, the following describes a forward convolution task based on the CNN illustrated in FIG. 1.

In step S21, the AR thread converts each of the deformed pieces of image data into a column vector, i.e. a column vector image. The time, referred to as T_{im2col}_{_}ₗ, required for the AR thread to perform the conversion based on the l-th layer of the CNN is expressed by the following equation (2E1′) using the map size xₗ and the number of maps mₗ in the l-th layer and the convolution filter size c of the CNN as long as the variable l is equal to or lower than Lc:

T_{im2col}_{_}ₗ=α11ₗ×xₗ×c²×mₗ₋₁×N_{Subbatch}+β11ₗ (2E1′)

Where α11ₗ and β11ₗ respectively represent fixed parameters, which depend on the learning system 100, and are each previously calculated by the parameter calculator 32.

The total time, referred to as T_{im2col}, required for the AR thread to perform the conversion defined in the equation (2E1′) with respect to all the layers of the convolution-layer portion of the CNN is expressed by the following equation (2E1):

$${T}_{im 2 col} = {\sum }_{l = 1}^{{L}_{c}} {T}_{im 2 col \_ l} \qquad ( 2 E1 )$$

In step S22, the AR thread performs convolution based on each of the column vectors. The time, referred to as T_{convolution}_{_}ₗ, required for the AR thread to perform convolution based on the l-th layer of the CNN is expressed by the following equation (2E2′):

T_{convolution}_{_}ₗ=α12ₗ×xₗ²×N_{Subbatch}×mₗc²×m_{i 1}+β12ₗ (2E2′)

Where α12ₗ and β12ₗ respectively represent fixed parameters, which depend on the learning system 100, and are each previously calculated by the parameter calculator 32.

The total time, referred to as T_{convolution}, required for the AR thread to perform the convolution based on the equation (2E2′) with respect to all the layers of the CNN is expressed by the following equation (2E2):

$${T}_{convolution} = {\sum }_{l = 1}^{L - 1} {T}_{convolution \_ l} \qquad ( 2 E2 )$$

In step S23, the AR thread performs a known full connection process based on the feature maps input to the l-th layer as long as the variable l is more than (Lc+1) to less than L.

Specifically, the AR thread performs, as the full connection process, known full connection and known activation using all the elements of the feature maps input to the l-th layer if the l-th layer is a full-connection layer. For example, assuming that each of the multilayer neural network structure 23 is a full-connection layer according to the first embodiment, the AR thread performs known full connection and known activation using all the elements of the feature maps input to the l-th layer while incrementing l by 1 from the (Lc+1) layer up to L.

The time, referred to as T_{fc}_{_}ₗ, required for the AR thread to perform the known full connection process based on the l-th layer of the CNN is expressed by the following equation (2E3′):

T_{fc}_{_}ₗ=α13ₗ×N_{Subbatch}×mₗxₗ₋₁²×mₗ₋₁+β13ₗ (2E3′)

Where α13ₗ and β13ₗ respectively represent fixed parameters, which depend on the learning system 100, and are each previously calculated by the parameter calculator 32.

The total time, referred to as T_{fc}, required for the AR thread to perform the known full connection process based on the equation (2E3′) with respect to all the layers from the (Lc+1) layer up to the L-th layer is expressed by the following equation (2E3):

$${T}_{fc} = {\sum }_{l = {L}_{c} + 1}^{L} {T}_{fc \_ l} \qquad ( 2 E3 )$$

In step S24, the AR thread performs addition of biases and an activation process based on the l-th layer of the CNN. The activation process uses a predetermined known activation function corresponding to the l-th layer. The time, referred to as T_{activation}_{_}ₗ, required for the AR thread to perform the addition of biases and the activation process based on the l-th layer of the CNN is expressed by the following equation (2E4′):

T_{activation}_{_}ₗ=α14ₗ×xₗ²×mₗ×N_{Subbatch}+β14ₗ (2E4′)

Where α14ₗ and β14ₗ respectively represent fixed parameters, which depend on the learning system 100, and are each previously calculated by the parameter calculator 32.

The total time, referred to as T_{activation}, required for the AR thread to perform the addition of the biases and the activation process based on the equation (2E4′) with respect to all the layers of the CNN is expressed by the following equation (2E4):

$${T}_{activation} = {\sum }_{l = 1}^{L - 1} {T}_{actication \_ l} \qquad ( 2 E4 )$$

In step S25, the AR thread performs a known pooling process, such as a known max pooling process, based on the l-th layer of the CNN as long as the variable 1 is equal to or lower than Lc. The time, referred to as T_{pooling}_{_}ₗ, required for the AR thread to perform the pooling process based on the l-th layer is expressed by the following equation (2E5′) using the pooling grid size pl:

T_{pooling}_{_}ₗ=15ₗ×pₗ² xₗ²×mₗ×N_{Subbatch}+β15ₗ (2E5′)

Where α16 and β16 respectively represent fixed parameters, which depend on the learning system 100, and are each previously calculated by the parameter calculator 32.

The total time, referred to as T_{pooling}, required for the AR thread to perform the known pooling process based on the equation (2E5′) with respect to all the layers of the CNN is expressed by the following equation (2E5):

$${T}_{poolong} = {\sum }_{l = 1}^{L - 1} {T}_{pooling \_ l} \qquad ( 2 E5 )$$

In step S26, the AR thread converts each of the feature maps into a column vector, i.e. a column vector image when the feature maps are input to the input layer of the multilayer neural network structure 23, that is, the variable l reaches Lc. The time, referred to as T_{c2f}, required for the AR thread to perform the conversion of each of the feature maps is expressed by the following equation (2E6):

T_{c2f}=α16×xₗ²×mₗ×N_{Subbatch}+β16 (2E6)

Where α16 and β16 respectively represent fixed parameters, which depend on the learning system 100, and are each previously calculated by the parameter calculator 32.

In step S27, the AR thread performs a known bias addition process based on the feature maps in the output layer. The time, referred to as T_{bias}, required for the AR thread to perform the bias addition process is expressed by the following equation (2E7):

T_{bias}=α17×m_{L}×N_{Subbatch}+17 (2E7)

Where α17 and β17 respectively represent fixed parameters, which depend on the learning system 100, and are each previously calculated by the parameter calculator 32.

In step S28, the AR thread performs a softmax process that performs activation of the outputs of the output layer using a softmax function. The time, referred to as T_{softmax}, required for the AR thread to perform the softmax process is expressed by the following equation (2E8):

T_{softmax}=α18×m_{L}×N_{Subbatch} (2E8)

Where α18 represents a fixed parameter, which depends on the learning system 100, and is previously calculated by the parameter calculator 32.

Next, the following describes a backpropagation task based on the CNN illustrated in FIG. 1.

In step S29, the AR thread calculates the differentiation of the cost function with respect to input values to the softmax function. The time, referred to as T_{softmax}_{_}_{B}, required for the AR thread to perform the calculation of the differentiation of the cost function with respect to the input values of the softmax function is expressed by the following equation (2E9):

T_{softmax}_{_}_{B}=α19×m_{L}×N_{Subbatch} (2E9)

Where α19 represents a fixed parameter, which depends on the learning system 100, and is previously calculated by the parameter calculator 32.

In step S30, the AR thread calculates known backpropagation for a future vector in the l-th layer when the variable l is equal to or more than Lc. The time, referred to as T_{dedx}_{_}_{fc}_{_}ₗ, required for the AR thread to perform the backpropagation for a future vector when the variable l is equal to or more than Lc is expressed by the following equation (2E10′):

T_{dedx}_{_}_{fc}_{_}₁=α20ₗ×N_{Subbatch}×xₗ²×mₗ×mₗ₊₁+β20ₗ (2E10′)

Where α20ₗ and β20ₗ respectively represent fixed parameters, which depend on the learning system 100, and are each previously calculated by the parameter calculator 32.

The total time, referred to as T_{dedx}_{_}_{fc}, required for the AR thread to perform the backpropagation based on the equation (2E10′) with respect to all the layers of the multilayer neural network structure 23 as long as the variable l is equal to or more than Lc is expressed by the following equation (2E10):

$${T}_{dedx \_ fc} = {\sum }_{i = L - 1}^{{L}_{c}} {T}_{dedx \_ fc \_ l} \qquad ( 2 E10 )$$

In step S31, the AR thread calculates the backpropagation for a future vector when the variable l is less than Lc. The time, referred to as T_{dedx}_{_}_{conv}_{_}₁, required for the AR thread to perform the backpropagation for a future vector in the l-th layer when the variable l is less than Lc is expressed by the following equation (2E11′):

T_{dedx}_{_}_{conv}_{_}₁=α21ₗ×xₗ₊₁²×N_{Subbatch}×c²×mₗ×mₗ₊₁+β21ₗ (2E11′)

Where α21ₗ and β21ₗ respectively represent fixed parameters, which depend on the learning system 100, and are each previously calculated by the parameter calculator 32.

The total time, referred to as T_{dedx}_{_}_{conv}, required for the AR thread to perform the backpropagation based on the equation (2E11′) with respect to all the layers of the convolution-layer portion as long as the variable l is less than Lc is expressed by the following equation (2E11):

$${T}_{dedx \_ conv} = {\sum }_{l = Lc - 1}^{1} {T}_{dedx \_ conv \_ l} \qquad ( 2 E11 )$$

In step S32, the AR thread performs back operation of the operation in step S26 in the l-th layer when the variable l reaches Lc. The time, referred to as T_{c2f}_{_}_{B}, required for the AR thread to perform the back operation of the operation in step S26 is expressed by the following equation (2E12):

T_{c2f}_{_}_{B}=α22×xₗ²×mₗ×N_{Subbatch}+β22 (2E12)

Where α22 and β22 respectively represent fixed parameters, which depend on the learning system 100, and are each previously calculated by the parameter calculator 32.

In step S33, the AR thread performs back operation of the operation in step S21 in the l-th layer when the variable l is less than Lc. The time, referred to as T_{im2col}_{_}_{B}, required for the AR thread to perform the back operation of the operation in step S21 is expressed by the following equation (2E13′):

T_{im2col}_{_}_{B}_{_}ₗ=α23ₗ×xₗ²×c²×mₗ×N_{Subbatch}+β23 ₗ (2E13′)

Where α23ₗ and β23ₗ respectively represent fixed parameters, which depend on the learning system 100, and are each previously calculated by the parameter calculator 32.

The total time, referred to as T_{im2col}_{_}_{B}, required for the AR thread to perform the back operation of the operation in step S21 based on the equation (2E13′) with respect to all the layers of the convolution-layer portion as long as the variable l is less than Lc is expressed by the following equation (2E13):

$${T}_{im 2 col \_ B} = {\sum }_{l = Lc - 1}^{1} {T}_{im 2 col \_ B \_ l} \qquad ( 2 E13 )$$

In step S34, the AR thread performs back operation of the operation in step S25 in the l-th layer when the variable l is less than Lc. The time, referred to as T_{pooling}_{_}_{B}_{_}₁, required for the AR thread to perform the back operation of the operation in step S25 in the l-th layer is expressed by the following equation (2E14′):

T_{pooling}_{_}_{B}_{_}ₗ=α24ₗ×xₗ²×mₗ×N_{Subbatch}+β24ₗ (2E14′)

Where α24ₗ and β24ₗ respectively represent fixed parameters, which depend on the learning system 100, and are each previously calculated by the parameter calculator 32.

The total time, referred to as T_{pooling}_{_}_{B}, required for the AR thread to perform the back operation of the operation in step S25 based on the equation (2E14′) with respect to all the layers of the convolution-layer portion as long as the variable l is less than Lc is expressed by the following equation (2E14):

$${T}_{pooling \_ B} = {\sum }_{l = Lc - 1}^{1} {T}_{pooling \_ B \_ l} \qquad ( 2 E14 )$$

In step S35, the AR thread calculates the differentiation of the cost function with respect to input values to a corresponding activation function in the l-th layer. The time, referred to as T_{activation}_{_}_{B}_{_}₁, required for the AR thread to perform the calculation of the differentiation of the cost function is expressed by the following equation (2E15′):

T_{activation}_{_}_{B}_{_}₁=α25ₗ×xₗ²×mₗ×N_{Subbatch}+β25ₗ (2E15′)

Where α25ₗ and β25ₗ respectively represent fixed parameters, which depend on the learning system 100, and are each previously calculated by the parameter calculator 32.

The total time, referred to as T_{actication}_{_}_{B}, required for the AR thread to perform the differentiation of the cost function based on the equation (2E15′) with respect to all the layers of the CNN is expressed by the following equation (2E15):

$${T}_{activation \_ B} = {\sum }_{l = L - 1}^{1} {T}_{activation \_ B \_ l} \qquad ( 2 E15 )$$

In step S36, the AR thread calculates the differentiation of the cost function with respect to the weights in the l-th layer. The time, referred to as T_{dedw}_{_}₁, required for the AR thread to perform the calculation of the differentiation of the cost function is expressed by the following equation (2E16′):

T_{dedw}_{_}₁=α26ₗ×cₗ₋₁²×mₗ₋₁×mₗ×xₗ²×N_{Subbatch}+26ₗ (2E16′)

Where α26ₗ and β26ₗ respectively represent fixed parameters, which depend on the learning system 100, and are each previously calculated by the parameter calculator 32.

The total time, referred to as T_{dedw}, required for the AR thread to perform the differentiation of the cost function based on the equation (2E16′) with respect to all the layers of the CNN is expressed by the following equation (2E16):

$${T}_{dedw} = {\sum }_{l = L}^{1} {T}_{dedw \_ l} \qquad ( 2 E16 )$$

In step S37, the AR thread calculates the differentiation of the cost function with respect to the biases in the l-th layer. The time, referred to as T_{dedb}_{_}₁, required for the AR thread to perform the calculation of the differentiation of the cost function with respect to the biases in the l-th layer is expressed by the following equation (2E17′):

T_{dedb}_{_}₁=α27ₗ×mₗ×xₗ²×N_{Subbatch}+β27ₗ (2E17′)

Where α27ₗ and β27ₗ respectively represent fixed parameters, which depend on the learning system 100, and are each previously calculated by the parameter calculator 32.

The total time, referred to as T_{dedb}, required for the AR thread to perform the differentiation of the cost function based on the equation (2E17′) with respect to all the layers of the CNN is expressed by the following equation (2E17):

$${T}_{dedb} = {\sum }_{l = L - 1}^{1} {T}_{dedb \_ l} \qquad ( 2 E17 )$$

Because the time T_{CNN} is configured as the total sum of the above equations (2E1) to (2E7), the above detailed descriptions enable the time T_{CNN} to be expressed by the following equation (2E):

T_{CNN}=T_{im2col}+T_{convolution}+T_{fc}+T_{activation}+T_{pooling}+T_{c2f}+T_{bias}+T_{softmax}+T_{softmax}_{_}_{B}+T_{dedx}_{_}_{fc}+T_{dedx}_{_}_{conv}+T_{c2f}_{_}_{B}+T_{im2col}_{_}_{B}+T_{pooling}_{_}_{B}T_{actication}_{_}_{B}+T_{dedw}+T_{dedb} (2E)

Returning to the equation (2), the time T_{ComputeUpdateVal} represents time required for calculations between vectors each having the length of N_{Param}, which is expressed by the following equation (2F):

T_{ComputeUpdateVal}=α4×N_{Param} (2F)

Where α4 represents a fixed parameter, which depends on the learning system 100, and is previously calculated by the parameter calculator 32.

The time T_{LockGradient}_{_}_{GPU} is expressed by the following equation (2G):

T_{LockGradient}_{_}_{GPU}=(T_{SumGradient}/N_{GPU})²/(2×T_{Allreduce}) (2G)

Where T_{SumGradient} is expressed by the equation (3B) described later.

The time T_{UpdateGradient} represents mainly transfer time to the host memory 14, which is expressed by the following equation (2H):

T_{UpdateGradient}=α5×N_{Param} (2H)

Where α5 represents a fixed parameter, which depends on the learning system 100, and is previously calculated by the parameter calculator 32.

Next, the following describes how the T_{GPU} and T_{Allreduce} calculator 42 calculates the time T_{Allreduce} in accordance with the equation (3).

To simplify the following descriptions, we show the equation (3) again as follows:

T_{Allreduce}=T_{LockGradient}_{_}_{AR}+T_{SumGradient}+T_{UpdateOldWeights}+T_{AddMomentum}+T_{MPI}_{_}_{Allreduce}+T_{UpdateMomentum}+T_{LockARResult}+T_{UpdateARResult} (3)

The time T_{LockGradient}_{_}_{AR} is expressed by the following equation (3A) like the time T_{LockARResult}_{_}_{GPU}:

T_{LockGradient}_{_}_{AR}=N_{GPU}×T_{UpdateGradient}²/(2×T_{GPU}) (3A)

The time T_{SumGradient}, which can be calculated like the time T_{FetchARResult}, is expressed by the following equation (3B):

T_{SumGradient}=α31 ×N_{GPU}×N_{Param}×min(T_{Allreduce}/T_{GPU}, 1) (3B)

Where α31 represents a fixed parameter, which depends on the learning system 100, and is previously calculated by the parameter calculator 32.

The time T_{UpdateOldWeights} represents time required for calculations of vectors each having the length that is inversely proportional to the node number N_{Node}, so that the time T_{UpdateOldWeights} is expressed by the following equation (3C):

T_{UpdateOldWeights}=α32 ×N_{Param}/N_{Node} (3C)

Where α32 represents a fixed parameter, which depends on the learning system 100, and is previously calculated by the parameter calculator 32.

The time T_{AddMomentum} represents time required for calculations of vectors each having the length that is inversely proportional to the node number N_{Node}, so that the time T_{AddMomentum} is expressed by the following equation (3D):

T_{AddMomentum}=α33×N_{Param}/N_{Node} (3D)

Where α33 represents a fixed parameter, which depends on the learning system 100, and is previously calculated by the parameter calculator 32.

The time T_{MPI}_{_}_{Allreduce} is expressed by the following equation (3E) when it is assumed that additions based on the additional Allreduce algorithm are carried out for each set of two nodes in all the nodes:

T_{MPI}_{_}_{Allreduce=(α}34×log N_{Node}+β34)×N_{Param} (3E)

Where α34 and β34 respectively represent fixed parameters, which depend on the learning system 100, and are each previously calculated by the parameter calculator 32.

The time T_{UpdateMomentum} represents time required for calculations of vectors each having the length that is inversely proportional to the node number N_{Node}, so that the time T_{UpdateMomentum} is expressed by the following equation (3F):

T_{UpdateMomentum}=α35×N_{Param}/N_{Node} (3F)

Where α35 represents a fixed parameter, which depends on the learning system 100, and is previously calculated by the parameter calculator 32.

The time T_{LockARResult}_{_}_{AR} is expressed by the following equation (3G) like the time T_{LockGradinet}_{_}_{AR}:

T_{LockARResult}_{_}_{AR}=N_{GPU}×T_{UFetchARResult}²/(2×T_{GPU}) (3G)

The time T_{UpdateARResult} represents time required for copying the array having the length of N_{Param} stored in the buffer RecvBuf to the buffer ARResultBuf in the host memory 14, which is expressed by the following equation (3H):

T_{UpdateARResult}=α36×N_{Param} (3H)

Where α36 represents a fixed parameter, which depends on the learning system 100, and is previously calculated by the parameter calculator 32.

The parameter calculator 32 definitely calculates the parameters α including α1 to α5, α11ₗ to α15ₗ, α16 to α19, α20ₗ, α21ₗ, α22, α23ₗ to α27ₗ, and α31 to α36, and the parameters β including β2, β3, β11ₗ to β15ₗ, β16, β17, β20ₗ, β21ₗ, β22, β23ₗ to β27ₗ, and β34. Then, the parameter calculator 32 inputs the calculated parameters α and β to the predictor 31. Then, the T_{GPU}·T_{Allreduce} calculator 42 of the predictor 31 solves the system of the equations (2), (2A) to (2H), (3), and (3A) to (3E) to calculate the time T_{GPU} and the time T_{Allreduce} accordingly.

For example, the T_{GPU}·T_{Allreduce} calculator 42 can be configured to repeatedly update the time T_{GPU} and the time T_{Allreduce} in accordance with the system of the equations (2), (2A) to (2H), (3), and (3A) to (3E) using a predetermined pair of default values for the respective time T_{GPU} and time T_{Allreduce}. This repetitive update continues until the deviations between the current values of the respective time T_{GPU} and time T_{Allreduce} from the immediately previous values of the respective time T_{GPU} and time T_{Allreduce} are sufficiently small. This repetitive update enables the current values of the respective time T_{GPU} and time T_{Allreduce} to be calculated as proper values of the respective time T_{GPU} and time T_{Allreduce}.

The T_{GPU}·T_{Allreduce} calculator 42 can be configured to calculate the time T_{GPU} and the time T_{Allreduce} using another numerical solution in accordance with, for example, the equations (2), (2A) to (2H), (3), and (3A) to (3E).

Next, the following describes how the parameter calculator 32 calculates the parameters a including α1 to α5, α11ₗ to α15ₗ to α16 to α19, α20ₗ, α21ₗ, α22, α23ₗ to α27ₗ, and α31 to α36, and the parameters β including β2, β3, β11ₗ to β15ₗ, β16, β17, β20ₗ, β21ₗ, β22, β23ₗ to β27ₗ, and β34. Because a method of calculating each of the parameters a is common to the others, and a method of calculating each of the parameters β is common to the others, the following describes how the parameter calculator 32 calculates the parameters α16 and β16 included in the equation (E26) and used in step S26 as a typical example.

In the equation (E26), the time T_{c2f} is given as a linear function of the sub-batch number N_{Subbatch}. The parameter calculator 32 executes a process P1 to perform step S26 using the learning system 100 in which at least a pair of different first and second values are used as the sub-batch number N_{Subbatch} for the learning system 100. Then, the parameter calculator 32 executes a process P2 to measure

(1) The first time T_{c2f}(1) required for the AR thread to perform the corresponding process, i.e. conversion of each of the feature maps, when the first value is used for the sub-batch number N_{Subbatch}

(2) The second time T_{c2f}(2) required for the AR thread to perform the corresponding process, i.e. conversion of each of the feature maps, when the second value is used for the sub-batch number N_{Subbatch}.

Then, the parameter calculator 32 executes a process P3 to perform linear regression analysis based on the first pair of the first value of the sub-batch number N_{Subbatch} and the first time T_{c2f}(1) and the second pair of the second value of the sub-batch number N_{Subbatch} and the second time T_{c2f}(2). This enables the values of the parameters α16 and β16 to be calculated.

Note that the parameter β16 should be ideally set to zero, but can be set to a nonzero value depending on the possibility that there is an overhead, for example, an excess or indirect computation time of the CPU when the CPU performs, for example, calls functions.

The other parameters α and β can be calculated in the same approach as the parameters α16 and β16, because the other parameters a and β are expressed in the respective linear functions of the sub-batch number N_{Subbatch}.

Note that the parameters α and β show the performance of the learning system, i.e. the computer cluster, 100, so that the parameters a and β are respectively set to constant values while the structure of the learning system, i.e. the computer cluster, 100 is kept unchanged.

Once the prediction apparatus 150 calculates the parameters α and β, it is possible to eliminate the need to calculate the parameters α and β each time the prediction apparatus 150 calculates the learning time T_{Epoch} and/or the average mini-batch size N_{Batch} unless as the prediction apparatus 150 uses another learning system. In other words, the prediction apparatus 150 has to calculate the parameters α and β when calculating the learning time T_{Epoch} and/or the average mini-batch size N_{Batch} if the prediction apparatus 150 uses another learning system.

As described above, the T_{GPU}·T_{Allreduce} calculator 42 of the predictor 31 calculates the time T_{GPU} and the time T_{Allreduce} using the parameters α and β previously calculated by the parameter calculator 32 in accordance with, for example, the equations (2), (2A) to (2H), (3), and (3A) to (3E). Then, the T_{Epoch} calculator 43 calculates the learning time T_{Epoch} using the time T_{GPU} in accordance with the equation (6). In addition, the N_{Batch} calculator 44 calculates the average mini-batch size N_{Batch} using the time T_{GPU} and the time T_{Allreduce} in accordance with the equation (5).

As described in detail above, the prediction apparatus 150 is configured to predict the learning time T_{Epoch} in accordance with the equation (6) as an example of the prediction model equations, and/or the average mini-batch size N_{Batch} in accordance with the equation (5) as an example of the prediction model equations when the parameters indicative of the CNN to be learned, the number of nodes of the learning system 100, and the sub-batch number N_{Subbatch} are input to the prediction apparatus 150.

This enables learning systems, each of which is capable of providing a proper mini-batch size and/or proper learning time based on the structure of the corresponding learning system, to be designed. More specifically, the prediction apparatus 150 enables learning systems, each of which has the proper number of nodes and/or the proper sub-batch number based on the proper learning time and/or the proper mini-batch size, to be designed.

While the illustrative embodiment of the present disclosure has been described herein, the present disclosure is not limited to the embodiment described herein, but includes any and all embodiments having modifications, omissions, combinations (e.g., of aspects across various embodiments), adaptations and/ or alternations as would be appreciated by those in the art based on the present disclosure. The limitations in the claims are to be interpreted broadly based on the language employed in the claims and not limited to examples described in the present specification or during the prosecution of the application, which examples are to be construed as non-exclusive.

What is claimed is:

1. A prediction apparatus for a learning system that includes a plurality of nodes each including a central processing unit and at least one graphics processing unit, the central processing unit of each node using the at least one graphics processing unit to calculate, based on a plurality of pieces of training data, a quantity of update of each weight included in a convolutional neural network, the central processing unit of each node performing a weight updating cycle that communicates the quantity of update of each weight with at least one other central processing unit of at least one other node to perform update of the corresponding weight of the convolutional neural network, the prediction apparatus comprising:
an obtaining unit configured to obtain, as input variables, at least one parameter indicative of a structure of the convolutional neural network, the number of the nodes of the learning system; and a sub-batch number indicative of the number of pieces of training data collectively processed by the at least one graphic processing unit; and
a predictor configured to predict at least one of learning time and an average mini-batch size as a function of the input variables obtained by the obtainer,
the learning time being time required for one update of all the weights by the central processing unit,
the average mini-batch size being an average number of pieces of training data used for the one update of all the weights.

2. The prediction apparatus according to claim 1, wherein the predictor is configured to predict the learning time in accordance with the following first equation:
T_{Epoch}=(N_{File}×T_{GPU})/(N_{Node}×N_{GPU}×N_{Subbatch})
Where T_{Epoch} represents the learning time;
N_{Node} represents the number of the nodes of the learning system;
N_{Subbatch} represents the sub-batch number;
N_{File} represents the total number of the plurality of pieces of training data;
N_{GPU} represents the number of the at least one graphics processing unit of each node; and
T_{GPU} represents time required for the at least one graphics processing unit to calculate a quantity of the one update of all the weights.

3. The prediction apparatus according to claim 1, wherein the predictor is configured to predict the average mini-batch size in accordance with the following second equation:
N_{Batch}=(N_{Node}×N_{GPU}×N_{Subbatch}×T_{Alleduce})/T_{GPU}
Where N_{Batch represents the average mini-batch size;}
N_{Node} represents the number of the nodes of the learning system;
N_{Subbatch} represents the sub-batch number;
N_{GPU} represents the number of the at least one graphics processing unit of each node;
T_{GPU} represents time required for the at least one graphics processing unit to calculate a quantity of the one update of all the weights; and
T_{Allreduce} represents time required for the central processing unit of each node to perform the weight updating cycle.

4. The prediction apparatus according to claim 3, wherein the central processing unit of each node carries out a plurality of processes to perform the weight updating cycle, and the time T_{Allreduce} is the sum of times required for the central processing unit of each node to carry out the respective processes.

5. The prediction apparatus according to claim 2, wherein the central processing unit of each node carries out a plurality of processes to perform the quantity of update of each weight, and the time T_{GPU} is the sum of times required for the central processing unit of each node to carry out the respective processes.

6. The prediction apparatus according to claim 4, wherein each of the times required for the central processing unit of each node to carry out the respective processes is given as a linear function of the sub-batch number.

7. The prediction apparatus according to claim 6, further comprising:
a parameter calculator configured to:
measure first time required for the CPU of each node to perform each of the processes when a first value is used for the sub-batch number;
measure second time required for the CPU of each node to perform each of the processes when a second value is used for the sub-batch number, the second value being different from the first value; and
perform, for each of the processes, linear regression analysis based on a first pair of the first value of the sub-batch number and the corresponding first time, and a second pair of the second value of the sub-batch number and the corresponding second time to calculate constants of the linear function of the sub-batch number for the corresponding one of the processes.

8. The prediction apparatus according to claim 1, further comprising:
a determiner configured to determine whether the average mini-batch size predicted by the predictor lies within a predetermined range.

9. The prediction apparatus according to claim 8, wherein the determiner is configured to:
select plural pairs of values of the number of nodes of the learning system and the sub-batch number, the calculated average mini-batch size lying within the predetermined range when each of the selected pairs of values of the number of nodes of the learning system and the sub-batch number is used in the convolutional neural network; and
identify one of the selected pairs of values of the number of nodes of the learning system and the sub-batch number, the learning time based on the identified one of the selected pairs of values of the number nodes of the learning system and the sub-batch number becoming minimum.

10. The prediction apparatus according to claim 8, wherein the determiner is configured to:
select plural pairs of values of the number of nodes of the learning system and the sub-batch number, the calculated average mini-batch size lying within the predetermined range when each of the selected pairs of values of the number of nodes of the learning system and the sub-batch number is used in the convolutional neural network; and
identify one of the selected pairs of values of the number of nodes of the learning system and the sub-batch number, the number of nodes of the learning system in the identified one of the selected pairs of values of the number of nodes the learning system and the sub-batch number becoming minimum.

11. The prediction apparatus according to claim 8, wherein the determiner is configured to:
select plural pairs of values of the number of nodes of the learning system and the sub-batch number, the calculated average mini-batch size lying within the predetermined range when each of the selected pairs of values of the number of nodes of the learning system and the sub-batch number is used in the convolutional neural network; and
identify one of the selected pairs of values of the number of nodes of the learning system and the sub-batch number, node time based on the identified one of the selected pairs of values of the number of nodes of the learning system and the sub-batch number becoming minimum,
the node time being defined as the product of the number of nodes of the learning system and the learning time.

12. A prediction method for a learning system that includes a plurality of nodes each including a central processing unit and at least one graphics processing unit, the central processing unit of each node using the at least one graphics processing unit to calculate, based on a plurality of pieces of training data, a quantity of update of each weight included in a convolutional neural network, the central processing unit of each node performing a weight updating cycle that communicates the quantity of update of each weight with at least one other central processing unit of at least one other node to perform update of the corresponding weight of the convolutional neural network, the prediction method comprising:
obtaining, as input variables, at least one parameter indicative of a structure of the convolutional neural network, the number of the nodes of the learning system; and a sub-batch number indicative of the number of pieces of training data collectively processed by the at least one graphic processing unit; and
predicting at least one of learning time and an average mini-batch size as a function of the input variables obtained by the obtainer,
the learning time being time required for one update of all the weights by the central processing unit,
the average mini-batch size being an average number of pieces of training data used for the one update of all the weights.

13. A computer program product for a learning system that includes a plurality of nodes each including a central processing unit and at least one graphics processing unit, the central processing unit of each node using the at least one graphics processing unit to calculate, based on a plurality of pieces of training data, a quantity of update of each weight included in a convolutional neural network, the central processing unit of each node performing a weight updating cycle that communicates the quantity of update of each weight with at least one other central processing unit of at least one other node to perform update of the corresponding weight of the convolutional neural network, the computer program product comprising:
a non-transitory computer-readable storage medium; and
a set of computer program instructions stored in the computer-readable storage medium, the instructions causing a computer to carry out:
a first step of obtaining, as input variables, at least one parameter indicative of a structure of the convolutional neural network, the number of the nodes of the learning system; and a sub-batch number indicative of the number of pieces of training data collectively processed by the at least one graphic processing unit; and
a second step of predicting at least one of learning time and an average mini-batch size as a function of the input variables obtained by the obtainer,
the learning time being time required for one update of all the weights by the central processing unit,
the average mini-batch size being an average number of pieces of training data used for the one update of all the weights.
